(19) United States
(12) Patent Application Publication
(10) Pub. No.: US 2007/0218278 A1
(43) Pub. Date: Sep. 20, 2007

(54) Method for Dyeing Microfibers and Fabric Woven with Microfibers Dyed Thereby

(76) Inventor: Sunghoon Choi, Seoul (KR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/659,208

(22) PCT Filed: Aug. 3, 2005
(86) PCT No.: PCT/KR05/02530

§ 371 Date: Mar. 13, 2007

(30) Foreign Application Priority Data
Aug. 4, 2004 (KR) 10-2004-0061287
Jul. 1, 2005 (KR) 10-2005-0059298

(51) Int. Cl. D02G 3/00; D04H 13/00; B32B 5/16; D06M 23/00

(52) U.S. Cl. 428/364; 442/365; 8/494

(57) ABSTRACT

The invention relates to a method for dyeing split-type microfibers made of a composite of polyester and polyamide by a yarn dyeing process. The method comprises: a weight reduction step comprising winding the microfibers on a yarn dyeing machine and adding an alkali agent at a uniform temperature of 100-130° G for 30-60 minutes to make a reduction of 6-15% in the weight of the microfibers; a water-washing step comprising injecting iron-free water at 70-80 0C onto the microfibers through a nozzle, applying water pressure to remove foreign materials while scouring the microfibers by the addition of a scouring agent, and treating the microfibers with acid to a pH of 4-5; a dyeing step of dyeing the microfibers under pressure by the addition of a dye together with a dispersant, a leveling agent, an antistatic agent and a softening agent; and water-washing and drying the dyed microfibers.

### TECHNICAL FIELD

The present invention relates to a method for dyeing microfibers, and more particularly, to a method for the yarn dyeing of split-type microfibers made of a composite of polyester and polyamide.

### BACKGROUND ART

Microfiber refers to fiber thinner than one denier, which has a three-dimensional structure and includes innumerable microspaces formed during splitting, and thus, is excellent in water absorption, washing properties, touch and insulation. Dish clothes, floorclothes, towels, gowns and the like, made of microfibers, get a good reputation, owing to excellent washing properties, rapid drying properties, excellent antibacterial and durable properties, and the like. However, in the case of fabrics for knitted wears, fashion socks and the like which will have a more effective value by the use of microfibers, products using microfibers do not yet appear. This is attributable to the fact that it is difficult to dye microfibers.

Dyeing methods can be divided into piece dyeing methods and yarn dyeing methods carried out before weaving; the prior methods for dyeing microfibers were generally performed by the piece dyeing methods. However, the dyeing of microfibers by the piece dyeing methods has a problem in that only woven or knitted fabrics with one color can be produced, because microfibers have very high migration property, which makes dyeing in various colors impossible. If socks knitted with microfibers and spandex are dyed after weight reduction at high temperature, there will be a problem in that the spandex melts so that the resulting products cannot function as socks. Accordingly, the production of microfiber woven or knitted fabrics with various colors or the dyeing of fabrics with various materials and designs should be performed by the piece dyeing.

However, in the prior art, the yarn dyeing of microfibers was attempted only by a method of conducting weight reduction and dyeing at the same time, and thus, did not attain good effects and was not used in practical applications. This is because the simultaneous conduction of weight reduction and dyeing makes the splitting of microfibers difficult and causes foreign matters occurring during the weight reduction process to interfere with the infiltration of dyes into fibers, resulting in reductions in absorption and dye fastness.

These problems occurring in the yarn dyeing of microfibers can be solved by the adoption of a method of dyeing after weight reduction. In the prior art, the method of dyeing after weight reduction was not attempted because it failed to understand either an appropriate water-washing method before dyeing after weight reduction or appropriate processing conditions in dyeing.

### DISCLOSURE OF INVENTION

The present invention has been made to solve the above problems occurring in the prior art, it is an object of the present invention to provide a method for dyeing microfibers after weight resuction, which allows yarn-dyed microfibers with high absorbance rate and dye fastness to be obtained and which uses the yarn-dyed microfibers as the material of woven or knitted fabrics to allow the production of various products woven with yarns of various colors while having the advantages of microfibers.

To achieve the above object, the present invention provides a method for dyeing split-type microfibers made of a composite of polyester and polyamide, the method comprising: (1) a weight reduction step comprising winding the microfibers on a yarn dyeing machine and adding an alkali agent to the wound microfibers at a uniform temperature of 100-130° C. for 30-60 minutes so as to make a reduction of 6-15% in the weight of the microfibers; (2) a water-washing step comprising injecting iron-free water at 70-80° C. onto the weight-reduced microfibers through a nozzle, applying water pressure to the microfibers to remove foreign materials while scouring the microfibers by the addition of a scouring agent, and treating the microfibers with acid to a pH of 4-5; (3) a dyeing step of dyeing the microfibers under pressure by the addition of a dye together with a dispersing agent, a leveling agent, an antistatic agent and a softening agent; and (4) water-washing and drying the dyed microfibers.

In the inventive method, the dyeing step may be performed by a two-step process where the polyamide is dyed after dyeing the polyester. Alternatively, the dyeing step may also be performed by a one-step process where the polyester and the polyamide are dyed at the same time.

In the dyeing step, the antibacterial agent together with the dye is preferably added.

Either yarn comprising the microfibers dyed by the above method or microfibers before dyeing may be processed to produce fancy yarns, such as slub yarn, nep yarn, loop yarn, chenille yarn, and feather yarn.

According to the inventive method for dyeing microfibers, it is possible to obtain split-type microfibers made of polyester and polyamide, which feel soft to touch, owing to weight reduction, and were dyed with the desired colors.

### BRIEF DESCRIPTION OF DRAWINGS

FIG. 1 is a schematic view showing a few thousand times enlargement of split-type microfibers made of a polyester-polyamide composite, which is to be dyed in the present invention.

### BEST MODE FOR CARRYING OUT THE INVENTION

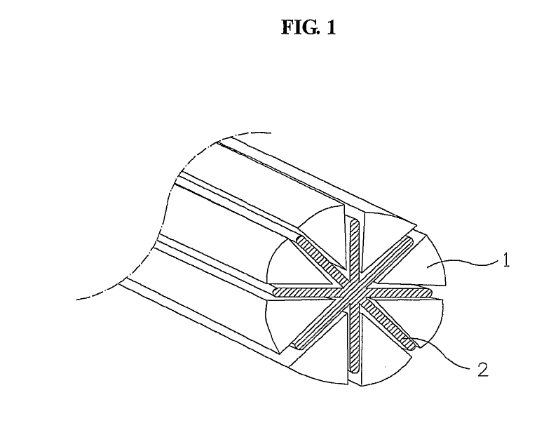

As shown in FIG. 1, microfibers to be dyed in the present invention are split-type microfibers (hereinafter, referred to as “microfibers”) made of a composite of polyester 1 and nylon 2. The microfibers consist of 70% polyester and 30% polyamide; this ratio may slightly vary depending on yarn's manufacturers.

Each of steps for the weight reduction, water washing and dyeing of microfibers is carried out in a state where the microfibers were wound on a cheese dyeing machine. Before winding, the microfiber yarn is preferably subjected to a twisting process to 100-1000 tpm (twist per meter). Conducting the twisting process increased the life span of woven fabrics and facilitated dyeing in experiments. Dyeing may be performed without twisting, but in which case, a number of points in yarn remain white without being dyed, making operation difficult.

The weight reduction step is performed at 100-130° C. for 30-60 minutes. As used herein, the term “weight reduction” refers to alkali weight reduction, which is typically conducted to improve the touch of polyester clothes. Sodium hydroxide (NaOH) is used as a reagent. By weight reduction, the polyester is hydrolyzed to produce insoluble byproducts, i.e., disodium terephthalate (hereinafter, referred to as “DST”) and ethylene glycol, and the polyamide is split to form spaces therebetween.

The weight reduction rate is in proportion to the concentration of NaOH and treatment temperature. Particularly, the treatment temperature has a great effect on the weight reduction rate, and thus, it must be kept at a uniform temperature of 100-130° C. The weight reduction rate is preferably 6-15%. If the weight reduction rate is higher than 15%, fluff will occur and also plucking will occur due to friction with other fabrics, resulting from a napping phenomenon. If the weight reduction rate is lower than 6%, water absorbance and rapid drying properties will deteriorate. For these reasons, the weight reduction rate must be necessarily checked during the weight reduction process.

After the weight reduction process, a water-washing process is carried out to remove the hydrolysis byproducts. The water washing is made by injecting clear water through a nozzle. Showering by injection via a nozzle must be done and this is because the byproducts placed in the yarn can be removed only when water is injected in high pressure. In the water-washing process, rapid cooling should be avoided and hot water with 70-80° C. should be used. The water used in the water washing process must have low calcium (Ca) and magnesium (Mg) contents and be free of iron (Fe). This is because the presence of iron ions causes dye staining or a change in color. In the water washing process, care is required so that the yarn is not elongated, and failure caused by insufficient water washing should be solved by physical methods.

In the water washing process, a scouring agent is added to remove impurities, and sodium triphosphate as needed is used to remove DST. Also, the alkali is treated with acid, and for this purpose, the alkali is preferably treated with an acidic agent (RC cleaning, produced by Hansol Chemical Co., Ltd., Korea) to adjust the yarn to a pH of 4.5. This is because when the yarn is maintained at high pH without treatment with acid, dyeing will not be well made. It is preferable that cationic agents should not be used if possible. This is because when the cationic agents bind to anionic dispersing or leveling agents or other oligomers, they will form insoluble salts, thus causing spots.

After completion of the water washing process, water is removed, and dyeing is performed as immediate as possible. In the dyeing process, high-pressure dispersion dyes are used and close attention is required. As the dye, dye for polyester or a composite of polyester and polyamide is used. Examples of this dye include dianix fla vaine xf, dianix red, and cbn xf, which are products of Dystar Co., Ltd. The yeing can be performed with various colors ranging from light colors to dark colors.

The dyeing is performed at a temperature of 100-130° C. under high pressure for 30˜60 minutes, in which dye is added while confirming an increase in temperature. Upon the addition of the dye, a dispersing agent, a leveling agent, a fiber softener and an antibacterial agent are added together with the dye. Moreover, chloroxylenol having an excellent effect on the removal of viruses is added together with the dye.

The dyeing may be performed either by a one-step process or by a two-step process where the polyamide is dyed after dyeing the polyester. The one-step process has shortcomings in that dye can be consumed in a three times larger amount than that in the two-step process, and dyeing failure can occur. Nevertheless, the one-step process can be considered because the two-step process is time-consuming and complicated. The two-step process is performed by dyeing the polyester with a disperse dye at 130° C. and then dyeing the polyamide with a dye for polyamide at 100° C. As the dye for polyamide, a disperse dye or an acidic dye may be used.

After completion of the dyeing process, the dyed yarn is washed with water to remove molten polyester and foreign materials, followed by drying. The dyed and dried yarn is used to weave or knit the desired fabrics.

Alternatively, after completion of the dyeing process, the dyed microfibers can be used to constitute a part or all of fancy yarns with design effects. The above dyed microfibers can be used alone or in combination with other yarns to make fancy yarn. Alternatively, after microfibers before dyeing are used to make fancy yarn, the fancy yarn may be dyed. Examples of the fancy yarn are as follows.

Chenille yarn is a kind of yarn for the decoration of the edge of embroideries and is used as weft to make chenille fabrics. The chenille yarns are arranged at intervals of a few warps and woven using yarns to be plied as wefts. The woven material is cut in the warp direction and twisted, thus obtaining thick fluffy yarns.

Slub yarn is a yarn obtained by making continuous soft knots on untwisted yarn using non-twisted yarn. The slub yarn is not uniform in thickness and has knots at a number of points.

Nep yarn is a single yarn which has small fluffs irregularly placed at a number of points and comprises knot-like shapes intermittently protruding from the surface thereof.

Loop yarn, also called “boucle yarn”, is a fancy twisted yarn having loops at a number of points, and frequently used in knitted wears or woolen fabrics.

Feather yarn is made by knitting warp and weft in various specifications with a needle to make clothes and cutting the clothes with a knife.

Since production methods of the above-described fancy yarns are well known to persons skilled in the art, the detailed description thereof will be omitted.

### EXAMPLE

Split-type microfibers made of a composite of 70% polyester and 30% polyamide were twisted to 250 tpm. The twisted yarn was wound on a cheese dyeing machine, and to the wound yarn, sodium hydroxide was added at a temperature of 130° C. for 30 minutes to make a reduction of 7% in the yarn weight. Onto the weight-reduced yarn, iron (Fe)-free water was injected by a shower device equipped with a nozzle injector to remove foreign materials. Molten parts of the polyester were removed by the application of water pressure. Then, the yarn was scoured by the addition of sodium hydroxide, and treated with acid (RC cleaning, a product of Hansol Chemical Co., Ltd.) to adjust the pH of the yarn to 4.5. Then, the yarn was dyed by the addition of a black dye (dianix black, a product of Dystar Co., Ltd.), dispersing agent DC-505 (produced by Shin Kwang Oil Chemical Co., Ltd, Korea), antistatic agent Anol-25B (produced by Shin Kwang Oil Chemical Co., Ltd, Korea), and softening agent 3M (produced by Shin Kwang Oil Chemical Co., Ltd, Korea), at 130° C. for 30 minutes. Then, the dyed yarn was removed from the dyeing machine, dried and wound on the bobbin of the dyeing machine. Then, the dyed yarn was woven together with spandex in a sock weaving machine to produce socks. The produced socks were measured for washing fastness, drying rate and absorption rate. For comparison, general black cotton socks were also measured for washing fastness, drying rate and absorption rate. The results are shown in Table 1 for washing fastness, Table 2 for drying rate, and Table 3 for absorption rate.

Components used in above Example and their use amounts are determined by a conventional method known in the art.

TABLE 1
Color fastness tested according to KS K
0430-2001, A-1, 40 ± 2° C.; unit: grade

| | | | Microfiber socks | Cotton socks |
|---|---|---|---|---|
| washing | Color change | | 4-5 | 4-5 |
| fastness | Color staining | Cotton | — | 4-5 |
| | | Nylon | 4 | 4-5 |
| | | Wool | 4-5 | — |

TABLE 2
Drying rate tested according to KS K 0815-
2001 6. 28. 1B, “evaporation free water amount”; unit:
g/202.5 cm²

| | Microfiber socks | Cotton socks |
|---|---|---|
| Drying rate | 27.49 | 18.29 |

TABLE 3
Absorption rate tested according to KS K
0815-2001 6. 27. 1B; unit: mm

| | | Microfiber socks | Cotton socks |
|---|---|---|---|
| Absorbance rate | Wale direction | 8 | 0 |
| | Course direction | 7 | 0 |

### INDUSTRIAL APPLICABILITY

As described above, according to the inventive method for dyeing microfibers, split-type microfibers made of a composite of polyester and polyamide can be obtained, which feel soft to touch, owing to weight reduction, and were dyed with the desired colors. The use of the dyed microfibers allows woven fabrics with various colors to be produced. Fabrics woven or knitted with the dyed microfibers are high-class products and provide various colors and functionalities so that they allow various products to be produced and create high-added value.

What is claimed is:

1. A method for dyeing split-type microfibers made of a composite of polyester and polyamide, the method comprising:
(1) a weight reduction step comprising winding the microfibers on a yarn dyeing machine and adding an alkali agent to the wound microfibers at a uniform temperature of 100-130° C. for 30-60 minutes so as to make a reduction of 6-15% in the weight of the microfibers;
(2) a water-washing step comprising injecting iron-free water at 70-80° C. onto the weight-reduced microfibers through a nozzle, applying water pressure to the microfibers to remove foreign materials while scouring the microfibers by the addition of a scouring agent, and treating the microfibers with acid to a pH of 4-5;
(3) a dyeing step of dyeing the microfibers under pressure by the addition of a dye together with a dispersing agent, a leveling agent, an antistatic agent and a softening agent; and
(4) water-washing and drying the dyed microfibers.

2. The method of claim 1, wherein the dyeing step is performed by a two-step process where the polyamide is dyed after dyeing the polyester.

3. The method of claim 1, wherein the dyeing step is performed by a one-step process where the polyester and the polyamide are dyed at the same time.

4. The method of claim 1, wherein, at the dyeing step, an antibacterial agent is added together with the dye.

5. A fancy yarn produced by processing a yarn comprising microfibers dyed by the method of claim 1.

6. The fancy yarn of claim 5, which is one selected from the group consisting of slub yarn, nep yarn, loop yarn, chenille yarn and feather yarn.

7. The method of claim 1, which further comprises, before the weight reduction step, the step of processing the microfibers to make fancy yarn.

8. The method of claim 7, wherein the fancy yarn is one selected from the group consisting of slub yarn, nep yarn, loop yarn, chenille yarn and feather yarn.

9. Fabrics woven or knitted with microfibers dyed by a method as set forth in any one of claims 1 to 4.

10. Fabrics woven or knitted with a fancy yarn as set forth in claim 5 or 7.
